(19) United States
(12) Patent Application Publication
(10) Pub. No.: US 2024/0233382 A9
(43) Pub. Date: Jul. 11, 2024

(54) MONITORING DEVICE, MONITORING SYSTEM, MONITORING METHOD, AND NON-TRANSITORY COMPUTER-READABLE MEDIUM STORING PROGRAM

(71) Applicant: NEC Corporation, Minato-ku, Tokyo (JP)

(72) Inventor: Yoshihiro Kajiki, Tokyo (JP)

(73) Assignee: NEC Corporation, Minato-ku, Tokyo (JP)

(21) Appl. No.: 18/275,322

(22) PCT Filed: Aug. 26, 2021
(86) PCT No.: PCT/JP2021/031388

§ 371 Date: Aug. 1, 2023

(51) Int. Cl. G06V 20/52; G06V 40/16; G06V 40/20; G10L 17/00

(52) U.S. Cl. CPC G06V 20/52; G06V 40/174; G06V 40/20; G10L 17/00

(57) ABSTRACT

Provided is a novel technology with which the occurrence of an abnormal situation can be detected and the abnormal situation can be appropriately ascertained. A monitoring device (1) comprises: a voice acquisition unit (2) that acquires prescribed speech spoken by a person due to the occurrence of an abnormal situation in a monitoring target area; a person identification unit (3) that identifies the person who spoke the prescribed speech, on the basis of a feature obtained from the prescribed speech; an analysis unit (4) that searches for the identified person in the images from a camera which images the monitoring target area, and that analyzes an expression or action of the person; and an abnormal situation evaluation unit (5) that evaluates the abnormal situation in the monitoring target area, on the basis of the analysis results.

### TECHNICAL FIELD

The present disclosure relates to a monitoring device, a monitoring system, a monitoring method, and a non-transitory computer-readable medium storing a program.

### BACKGROUND ART

In recent years, crimes such as burglaries targeting stores and other businesses operated by one person have been on the rise. In order to prevent this, an increasing number of stores and other businesses are installing monitoring cameras and outsourcing monitoring to security companies. In reality, however, security companies contracted with a large number of customers do not always see individual monitoring camera videos and will not monitor them unless alerted by an emergency button or other means. In addition, the employee may not be able to press the emergency button, for example, because the employee is being threatened by a burglar. Therefore, there is a limit to a monitoring method in which a person monitors the videos from monitoring cameras.

In order to solve this problem, an intelligent monitoring method has been proposed in which monitoring camera videos are monitored by a computer. For example, Patent Literature 1 discloses a monitoring method in which not only a monitoring camera but also a microphone is installed, and the acquired videos and sounds are analyzed by a program to detect the occurrence of abnormal situations.

In general, in the case of detecting an abnormality from a video, as described in Patent Literature 1, video data from monitoring cameras is collected via a network and analyzed by a computer. In the video analysis, video features that lead to danger, such as a face image of a specific person, an abnormal behavior of a single person or a plurality of persons, or an object left in a specific place, are pre-registered, and the presence of the features is detected.

In addition to video, sound is also used to detect abnormalities, as described in Patent Literature 1. For sound, there is voice recognition, which recognizes and analyzes the content of human speech, and acoustic analysis, which analyzes sounds other than voice, but neither of them requires significant computer resources. Therefore, even a central processing unit (CPU) for embedded applications, such as those installed in a smartphone, can sufficiently perform analysis in real time.

Detection of occurrence of an abnormal situation by analyzing sound is also effective for unexpected abnormal situations. This is because it is a universal natural law that a person encountering an abnormal situation screams or shouts.

In addition, sound diffuses in all directions in 360 degrees, propagates even in the dark, and has a property of going around even if there is an obstacle on the way. For this reason, sound-based monitoring has the advantage of not being limited by the field of view, direction, or lighting, as is the case with camera-based monitoring, and it does not miss screams or loud voices that occur in the dark or in the shadows.

Furthermore, in a case where sound is collected by a plurality of microphones, as disclosed in Patent Literature 2, the position of the sound source can be estimated from the difference in arrival time of the sound from the sound source to each microphone, the difference in sound pressure due to diffusion and attenuation of the sound, and other factors.

In addition, Patent Literature 3 discloses a technology of estimating a posture from joint positions of a person appearing in an image. By applying this to a video, the behavior of the person is estimated from arm and hand motions.

In addition, Patent Literature 4 discloses a technology called facial expression recognition, which recognizes facial expressions from human face images.

### CITATION LIST

### Patent Literature

Patent Literature 1: Japanese Unexamined Patent Application Publication No. 2013-131153
Patent Literature 2: Published Japanese Translation of PCT International Publication for Patent Application, No. 2013-545382
Patent Literature 3: Japanese Unexamined Patent Application Publication No. 2021-086322
Patent Literature 4: International Patent Publication No. 2019/102619

### SUMMARY OF INVENTION

### Technical Problem

It is difficult to detect the occurrence of an unexpected abnormal situation by focusing only on features obtained from videos. That is, it is difficult to define video features in advance that can detect the occurrence of abnormal situations by the video features alone. Detection of the occurrence of an abnormality by video analysis requires predefined video features corresponding to each abnormality. That is, the detection of the occurrence of abnormal situations from video requires the preparation of a program for analysis (for example, a program that generates a classifier by machine learning) based on predefined video features for various abnormal situations. However, in the actual society, there are various physiognomic features, belongings, and behaviors of criminal suspects and victims, and various crimes and accidents occur. For this reason, unless some preconditions are added, it is difficult to define video features corresponding to abnormal situations in advance, and methods of detecting the occurrence of abnormal situations only from video lacks practicality.

For example, Patent Literature 1 describes an example of pre-registering face images of specific persons, but since face images of all persons causing unexpected abnormal situations are not collected in advance, abnormality detection using face images and physiognomic characteristics as video features has limited applications. Patent Literature 1 also describes an example of pre-registering a single or a plurality of person's abnormal behavior. However, for example, there is little difference between the behavior of receiving payment from a customer and handing over change from a cash register and the behavior of handing over cash from a cash register after being threatened by a burglar. For this reason, it is difficult to determine abnormal behavior from the video features of the parties involved.

On the other hand, as described above, detection of the occurrence of an abnormal situation by analyzing sound is also effective for unexpected abnormal situations. However, sound analysis alone cannot evaluate whether or not a response is required for the detected abnormal situation.

Therefore, one of the objects to be achieved by the embodiments disclosed herein is to provide a novel technique that can detect the occurrence of an abnormal situation and appropriately ascertain the abnormal situation.

### Solution to Problem

A monitoring device according to a first aspect of the present disclosure includes:
a voice acquisition means for acquiring a predetermined voice uttered by a person due to the occurrence of an abnormal situation in a monitoring target area;
a person identification means for identifying the person who uttered the predetermined voice based on features obtained from the predetermined voice;
an analysis means for searching for the identified person from a video from a camera shooting the monitoring target area and analyzing a facial expression or a motion of the person; and
an abnormal situation evaluation means for evaluating the abnormal situation in the monitoring target area based on a result of the analysis.

A monitoring system according to a second aspect of the present disclosure includes:
a camera configured to shoot a monitoring target area;
a sensor configured to detect a sound generated in a monitoring target area; and
a monitoring device, in which
the monitoring device includes:
a voice acquisition means for acquiring, from the sensor, a predetermined voice uttered by a person due to the occurrence of an abnormal situation in the monitoring target area;
a person identification means for identifying the person who uttered the predetermined voice based on features obtained from the predetermined voice;
an analysis means for searching for the identified person from a video from the camera and analyzing a facial expression or a motion of the person; and
an abnormal situation evaluation means for evaluating the abnormal situation in the monitoring target area based on a result of the analysis.

A monitoring method according to a third aspect of the present disclosure includes:
acquiring a predetermined voice uttered by a person due to the occurrence of an abnormal situation in a monitoring target area;
identifying the person who uttered the predetermined voice based on features obtained from the predetermined voice;
searching for the identified person from a video from a camera shooting the monitoring target area and analyzing a facial expression or a motion of the person; and
evaluating the abnormal situation in the monitoring target area based on a result of the analysis.

A program according to a fourth aspect of the present disclosure causes a computer to execute:
a voice acquisition step of acquiring a predetermined voice uttered by a person due to the occurrence of an abnormal situation in a monitoring target area;
a person identification step of identifying the person who uttered the predetermined voice based on features obtained from the predetermined voice;
an analysis step of searching for the identified person from a video from a camera shooting the monitoring target area and analyzing a facial expression or a motion of the person; and
an abnormal situation evaluation step of evaluating the abnormal situation in the monitoring target area based on a result of the analysis.

### Advantageous Effects of Invention

According to the present disclosure, a novel technique that can detect the occurrence of an abnormal situation and properly ascertain the abnormal situation can be provided.

### BRIEF DESCRIPTION OF DRAWINGS

FIG. 1 is a block diagram illustrating an example of a configuration of a monitoring device according to an outline of an example embodiment.

FIG. 2 is a flowchart illustrating an example of the flow of operation of a monitoring device according to an outline of an example embodiment.

FIG. 3 is a schematic diagram illustrating an example of a configuration of a monitoring system according to an example embodiment.

FIG. 4 is a block diagram illustrating an example of the functional configuration of an acoustic sensor.

FIG. 5 is a block diagram illustrating an example of the functional configuration of an analysis server.

FIG. 6 is a schematic diagram illustrating an example of the hardware configuration of a computer.

FIG. 7 is a flowchart illustrating an example of the flow of operation of a monitoring system according to an example embodiment.

FIG. 8 is a flowchart illustrating an example of the flow of processing in step S107 in the flowchart illustrated in FIG. 7.

### EXAMPLE EMBODIMENT

### Outline of Example Embodiments

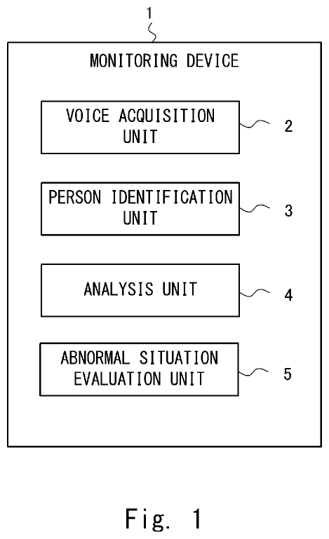

Before describing the details of an example embodiment, an outline of the example embodiment will be described. FIG. 1 is a block diagram illustrating an example of a configuration of a monitoring device 1 according to the outline of an example embodiment. As illustrated in FIG. 1, the monitoring device 1 is a device for monitoring a predetermined monitoring target area, including a voice acquisition unit 2, a person identification unit 3, an analysis unit 4, and an abnormal situation evaluation unit 5.

The voice acquisition unit 2 acquires a predetermined voice uttered by a person due to the occurrence of an abnormal situation in a monitoring target area. Here, a predetermined voice is a voice uttered when a person encounters an abnormal situation, and is, for example, a scream or shout. The voice acquisition unit 2 acquires, for example, a scream or shout collected by a microphone installed in a monitoring target area.

The person identification unit 3 identifies the person who uttered the predetermined voice based on features obtained from the predetermined voice acquired by the voice acquisition unit 2. For example, the person identification unit 3 identifies, based on the features obtained from the predetermined voice and the voice features of the pre-registered persons, which of the persons whose voice features are registered corresponds to the person who uttered the predetermined voice.

The analysis unit 4 searches for the person identified by the person identification unit 3 from the video from the camera shooting the monitoring target area, and analyzes the facial expression or motion of the person. For example, the analysis unit 4 analyzes whether or not the facial expression of the searched person in the video is the predetermined expression. Here, the predetermined facial expression is a facial expression that appears when a person encounters an abnormal situation, and specifically, for example, is a frightened facial expression or an angry facial expression. Furthermore, for example, the analysis unit 4 analyzes whether or not the motion of the searched person in the video is the predetermined motion. Here, the predetermined motion may be, for example, a series of motions or gestures performed by a person encountering an abnormal situation. Note that the analysis unit 4 may perform the analysis of the facial expression and/or motion.

The abnormal situation evaluation unit 5 evaluates the abnormal situation in the monitoring target area based on the results of analysis by the analysis unit 4. For example, the abnormal situation evaluation unit 5 calculates an index (for example, score) for determining whether or not the situation is an abnormal situation requiring a response. In addition, the abnormal situation evaluation unit 5 may determine whether or not the situation is an abnormal situation that requires a response based on that index.

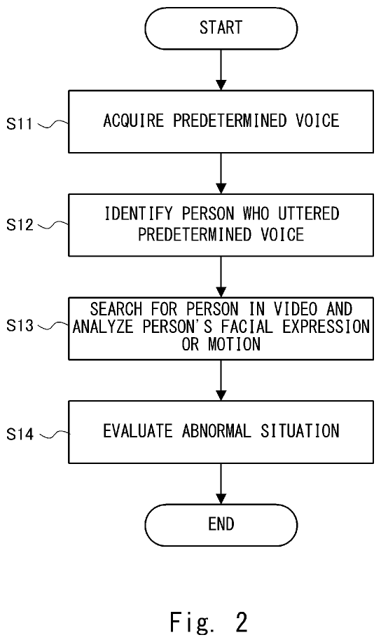

FIG. 2 is a flowchart illustrating an example of the flow of operation of a monitoring device 1 according to an outline of an example embodiment. An example of the flow of operation of the monitoring device 1 is described below with reference to FIG. 2.

First, in step S11, the voice acquisition unit 2 acquires a predetermined voice uttered by a person due to the occurrence of an abnormal situation in a monitoring target area.

Next, in step S12, the person identification unit 3 identifies the person who uttered the predetermined voice based on features obtained from the predetermined voice acquired by the voice acquisition unit 2.

Next, in step S13, the analysis unit 4 searches for the person identified by the person identification unit 3 from the video from the camera shooting the monitoring target area, and analyzes the facial expression or motion of the person.

Next, in step S14, the abnormal situation evaluation unit 5 evaluates the abnormal situation in the monitoring target area based on the results of analysis by the analysis unit 4.

The monitoring device 1 according to the example embodiment has been described above. The monitoring device 1 performs processing using voice and video, whereby the occurrence of an abnormal situation can be detected and the abnormal situation can be appropriately ascertained.

### Details of Example Embodiments

Next, details of the example embodiment will be described.

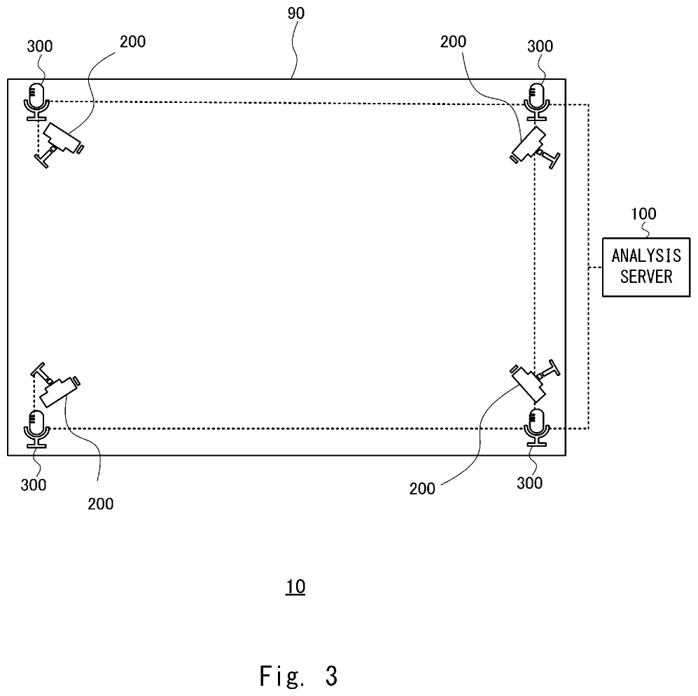

FIG. 3 is a schematic diagram illustrating an example of a configuration of a monitoring system 10 according to an example embodiment. In the present example embodiment, the monitoring system 10 includes an analysis server 100, a monitoring camera 200, and an acoustic sensor 300. The monitoring system 10 is a system for monitoring a predetermined monitoring target area 90. The monitoring target area 90 is, for example, a store, a financial institution, or the like, but, not limited thereto, may be any area to be monitored.

The monitoring camera 200 is a camera installed to shoot the monitoring target area 90. The monitoring camera 200 shoots the monitoring target area 90 and generates video data. The monitoring camera 200 is installed at an appropriate position where the entire monitoring target area 90 can be monitored. Note that a plurality of monitoring cameras 200 may be installed to monitor the entire monitoring target area 90.

In the present example embodiment, the acoustic sensors 300 are provided at various locations within the monitoring target area 90. Specifically, the acoustic sensors 300 are installed at intervals of, for example, about 10 to 20 meters. The acoustic sensor 300 collects and analyzes sound in the monitoring target area 90. Specifically, the acoustic sensor 300 is a sound sensing device including a microphone, a sound device, a CPU, and the like. The acoustic sensor 300 collects ambient sound with a microphone, converts the sound into a digital signal with a sound device, and then performs acoustic analysis with a CPU. In this acoustic analysis, for example, abnormal sounds such as a scream or shout is detected. Note that the acoustic sensor 300 may be equipped with a voice recognition function. In that case, more sophisticated analysis can be performed, such as estimating the severity of an abnormal situation by recognizing the content of speech, such as a shout.

In the present example embodiment, the acoustic sensors 300 are installed at various locations within the monitoring target area 90 at intervals of about 10 to 20 meters so that a plurality of acoustic sensors 300 can detect abnormal sounds wherever they occur in the area. In general, the noise level in a store or the like is about 60 decibels, whereas screams and shouts have a loudness of about 80 to 100 decibels. However, for example, at a distance of 10 meters from the sound occurrence position, an abnormal sound that was 100 decibels near the sound source is attenuated to 80 decibels. Here, if the distance from the sound source to the acoustic sensor 300 is too far, it becomes difficult to distinguish the background noise of about 60 decibels from the attenuated abnormal sound at the location of the acoustic sensor 300. Therefore, in the present example embodiment, the acoustic sensors 300 are arranged at the intervals described above. The interval at which the plurality of acoustic sensors 300 can detect the same abnormal sound depends on the background noise level and the performance of each acoustic sensor 300, and is not necessarily limited to 10 to 20 meters.

The analysis server 100 is a server for analyzing data obtained by the monitoring camera 200 and the acoustic sensors 300, and has the function of the monitoring device 1 illustrated in FIG. 1. The analysis server 100 receives analysis results from the acoustic sensors 300, and, as necessary, acquires video data from the monitoring camera 200 and analyzes the video. The analysis server 100 and the monitoring camera 200 are communicably connected via a network 500. Similarly, the analysis server 100 and the acoustic sensors 300 are communicably connected via the network 500. The network 500 is a network that transmits communication between the monitoring camera 200, the acoustic sensors 300, and the analysis server 100, and may be a wired network or a wireless network.

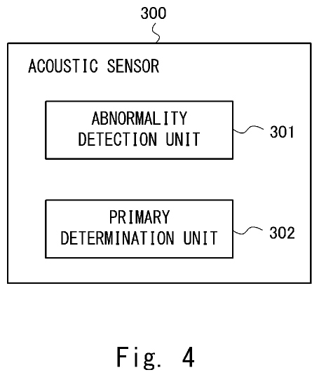

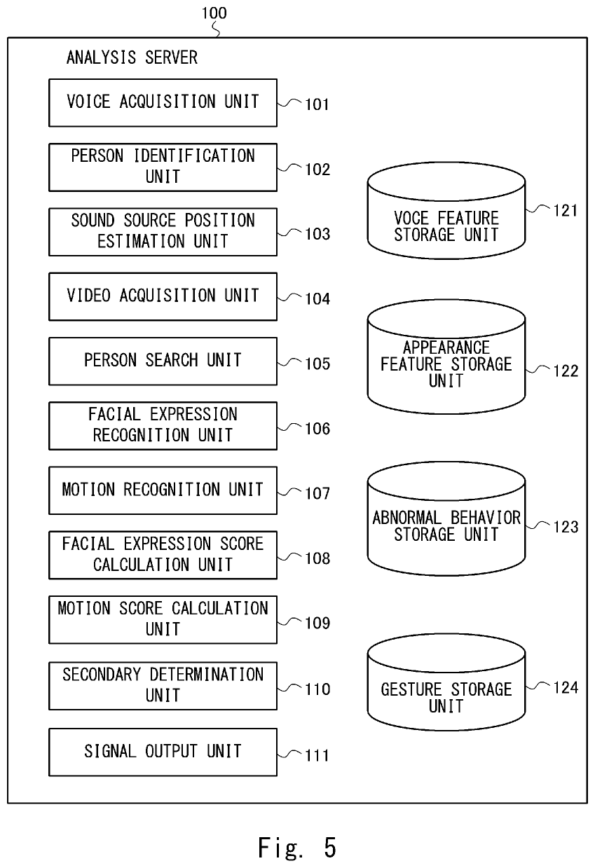

FIG. 4 is a block diagram illustrating an example of the functional configuration of the acoustic sensor 300. FIG. 5 is a block diagram illustrating an example of the functional configuration of the analysis server 100.

As illustrated in FIG. 4, the acoustic sensor 300 includes an abnormality detection unit 301 and a primary determination unit 302.

The abnormality detection unit 301 detects the occurrence of an abnormal situation in the monitoring target area 90 based on the sound detected by the acoustic sensor 300. The abnormality detection unit 301 detects the occurrence of an abnormal situation by determining, for example, whether or not the sound detected by the acoustic sensor 300 corresponds to a predetermined abnormal sound (specifically, for example, a voice such as a scream or shout). That is, when the sound detected by the acoustic sensor 300 corresponds to a predetermined abnormal sound, the abnormality detection unit 301 determines that an abnormal situation has occurred in the monitoring target area 90. In the present example embodiment, when the abnormality detection unit 301 determines that an abnormal situation has occurred, it calculates a score indicating the degree of abnormality. For example, the abnormality detection unit 301 may calculate a higher score the louder the voice is.

When the occurrence of an abnormal situation is detected, the primary determination unit 302 determines whether or not no response is required for the abnormal situation. For example, the primary determination unit 302 makes this determination by comparing the score calculated by the abnormality detection unit 301 with a preset threshold value. That is, in a case where the calculated score is equal to or less than the threshold value, the primary determination unit 302 determines that no response is required for the detected abnormal situation. In this case, no further processing in the monitoring system 10 is performed. On the other hand, in a case where it is not determined that no response is required for the abnormal situation, the occurrence of the abnormal situation is notified from the acoustic sensor 300 to the analysis server 100. Note that this notification processing may be performed as processing in the abnormality detection unit 301.

When the occurrence of an abnormal situation is notified from the acoustic sensor 300 to the analysis server 100, processing in the analysis server 100 described later is performed. As described above, in the present example embodiment, whether or not the processing in the analysis server 100 is performed is determined according to the determination result of the primary determination unit 302, but the processing in the analysis server 100 may be performed regardless of the determination result of the primary determination unit 302. That is, the processing in the analysis server 100 may be performed in all cases where the abnormality detection unit 301 detects the occurrence of an abnormal situation. That is, the determination processing by the primary determination unit 302 may be omitted.

As illustrated in FIG. 5, the analysis server 100 includes a voice acquisition unit 101, a person identification unit 102, a sound source position estimation unit 103, a video acquisition unit 104, a person search unit 105, a facial expression recognition unit 106, a motion recognition unit 107, a facial expression score calculation unit 108, a motion score calculation unit 109, a secondary determination unit 110, a signal output unit 111, a voice feature storage unit 121, an appearance feature storage unit 122, an abnormal behavior storage unit 123, and a gesture storage unit 124.

The voice acquisition unit 101 acquires a predetermined voice uttered by a person due to the occurrence of an abnormal situation in the monitoring target area 90. Specifically, a predetermined voice (a scream or shout) detected by the acoustic sensor 300 is acquired from the acoustic sensor 300. Specifically, when the occurrence of an abnormal situation is notified from the acoustic sensor 300 to the analysis server 100, the voice acquisition unit 101 acquires the voice from the acoustic sensor 300.

The person identification unit 102 identifies the person who uttered the predetermined voice based on features obtained from the predetermined voice acquired by the voice acquisition unit 101. In the present example embodiment, the person identification unit 102 identifies the person who uttered the predetermined voice by matching the features of the voice stored in the voice feature storage unit 121 with the features obtained from the predetermined voice acquired by the voice acquisition unit 101.

The voice feature storage unit 121 is a database that store, for each person (for example, an employee) who may be present in the monitoring target area 90, the person's identification information in association with the voice features of the person. The person identification unit 102 identifies which of the persons whose voice features are registered corresponds to the person who uttered the predetermined voice by comparing the voice characteristics. Examples of voice features used include, but are not limited to, the base frequency of formants and fluctuations associated with the opening and closing of the vocal cords. In order to identify a person, the person identification unit 102 performs predetermined voice analysis processing from the voice acquired by the voice acquisition unit 101 to extract features.

Note that the person identification unit 102 does not necessarily have to identify one person as the person corresponding to the predetermined voice acquired by the voice acquisition unit 101. When the voice acquisition unit 101 acquires voices of a plurality of persons, the person identification unit 102 may identify each of the plurality of persons. Further, it is not necessary to identify one person for each voice acquired by the voice acquisition unit 101. For example, in a case where a plurality of persons having similar voice features are registered, the person identification unit 102 may identify a plurality of candidates who have uttered a predetermined voice.

The sound source position estimation unit 103 estimates the occurrence position of the abnormal situation by estimating the source of the sound detected by the acoustic sensor 300 provided in the monitoring target area 90. Specifically, when the occurrence of an abnormal situation is notified from the plurality of acoustic sensors 300 to the analysis server 100, the sound source position estimation unit 103 performs known sound source position estimation processing disclosed in, for example, Patent Literatures 2 on the voice data collected from the plurality of acoustic sensors 300. That is, for example, the sound source position estimation unit 103 may estimate the sound source position of the voice based on the difference in arrival time of the voice to microphones provided at a plurality of positions in the monitoring target area 90, or the difference in sound pressure due to sound diffusion and attenuation. As a result, the sound source position estimation unit 103 estimates the sound source position of the predetermined voice, that is, the occurrence position of the abnormal situation.

When the occurrence position of the abnormal situation is estimated by the sound source position estimation unit 103, the video acquisition unit 104 acquires video data from the monitoring camera 200 shooting the estimated position. Note that, for example, the analysis server 100 has pre-stored information indicating which areas are being shot by each of the monitoring cameras 200 and the video acquisition unit 104 compares this information with the estimated position to identify the monitoring camera 200 shooting the estimated position.

The person search unit 105 searches for the person who uttered the abnormal sound from the video in the vicinity of the occurrence position of the abnormal situation. That is, the person search unit 105 searches for the person identified by the person identification unit 102 from the video acquired by the video acquisition unit 104. When the person identification unit 102 identifies a plurality of persons, the person search unit 105 performs search processing on the plurality of persons. In the present example embodiment, the person search unit 105 searches for the person identified by the person identification unit 102 from the video by matching the appearance features of the person stored in the appearance feature storage unit 122 with the appearance features of the person extracted from the video acquired by the video acquisition unit 104.

The appearance feature storage unit 122 is a database that store, for each person (for example, an employee) who may be present in the monitoring target area 90, that is, for each person whose voice features are registered in the voice feature storage unit 121, the person's identification information in association with the appearance features of the person. Specifically, the person search unit 105 searches for the person identified by the person identification unit 102 by detecting people from the videos, extracting features of the appearance of each person, and matching them with the features of the appearance of the person previously registered in the appearance feature storage unit 122. Here, the appearance features may be facial features, features of clothing or a hat, or a code (for example, a barcode or a two-dimensional code) printed on an ID card worn by an employee. That is, the appearance features can be any different appearance features for each person that can be acquired from the video. In order to search for a person, the person search unit 105 performs predetermined image analysis processing to extract features from the video acquired by the video acquisition unit 104. When the person search unit 105 search for a person, it assigns an annotation to the video data that identifies the searched person in the video.

The facial expression recognition unit 106 recognizes the facial expression of the person identified by the person identification unit 102, that is, the person searched by the person search unit 105. Specifically, for example, the facial expression recognition unit 106 performs known facial expression recognition processing on the above-described annotated video data to recognize the facial expression (facial expressions representing psychological states such as calm, laughter, anger, and fear). For example, the facial expression recognition unit 106 may recognize the facial expression by performing the processing disclosed in Patent Literature 4 on the face image. In particular, the facial expression recognition unit 106 analyzes whether or not the facial expression appearing on the face of a person is a predetermined facial expression. Here, the predetermined facial expression is specifically, for example, a frightened facial expression or an angry facial expression. For example, it is assumed that the person who uttered an abnormal voice is a clerk. In this case, when a clerk who would normally serve customers with a smile will lose the smile and change to a facial expression such as fearful when encountering an abnormal situation such as a burglary. Therefore, by detecting such a facial expression, that is, a psychological state causing such a facial expression, the abnormal situation can be ascertained in more detail.

The motion recognition unit 107 recognizes the motion of the person identified by the person identification unit 102, that is, the person searched by the person search unit 105. Specifically, for example, the motion recognition unit 107 performs known motion recognition processing on the above-described annotated video data to recognize the motion. For example, the motion recognition unit 107 identifies the motion and posture of arms, hands, and legs by tracking the joint positions of a person using techniques such as those disclosed in Patent Literature 3 for images. In particular, the motion recognition unit 107 analyzes whether or not the motion of the person is a predetermined motion. Here, the predetermined motion may be a pre-registered motion, for example, a series of actions performed by a person encountering an abnormal situation, or it may be a gesture (pose).

In the present example embodiment, when the motion recognition unit 107 recognized the motion of a person, it determines whether or not the person has performed the motion performed by a person encountering an abnormal situation by matching the recognized motion with a series of actions stored in the abnormal behavior storage unit 123. That is, the motion recognition unit 107 analyzes whether or not the recognized motion of the person is similar to a series of predefined motions. When the degree of similarity between the two is equal to or greater than a predetermined threshold value, the motion recognition unit 107 may determine that a series of predefined motions has actually been performed. The abnormal behavior storage unit 123 is a database that stores information representing a series of motions performed by a person who encountering an abnormal situation. The series of motions registered in the abnormal behavior storage unit 123 may be one or more. For example, in a case where the monitoring target area 90 is a store, when a clerk is attacked by a burglar, the clerk may take out money from the cash register and hand the money to the burglar. Therefore, as a series of motions performed by a person encountering an abnormal situation, information representing a motion in which the arm of the person to be determined (the clerk who uttered an abnormal voice) moves in the direction of the cash register, takes out something with his/her hand, and offers it to the person in front of him-her may be stored in the abnormal behavior storage unit 123.

In the present example embodiment, when the motion recognition unit 107 recognized the motion of a person, it determines whether or not the person has performed the motion performed by a person encountering an abnormal situation by matching the recognized motion with gestures stored in the gesture storage unit 124. That is, the motion recognition unit 107 analyzes whether or not the recognized motion (gesture) of the person is similar to a predefined gesture. When the degree of similarity between the two is equal to or greater than a predetermined threshold value, the motion recognition unit 107 may determine that a predefined gesture has actually been performed.

The gesture storage unit 124 is a database that stores information representing gestures that employees and others have been pre-trained to perform when encountering an abnormal situation. The gestures registered in the gesture storage unit 124 may be one or more. For example, in a case where the monitoring target area 90 is a store, clerks or other employees should be trained that if they are attacked by a burglar, they should shout and make a gesture of extending their left hand upward while complying with the burglar's demands. In this case, information indicating the gesture of extending the left hand upward is pre-stored in the abnormal behavior storage unit 123. Note that, the gesture to be registered should preferably be gestures that are rarely seen in normal employee behavior, that are not unnatural in the event of an abnormal situation, and that are easily detected by video analysis. In this manner, by pre-registering gestures, abnormal situations that require responses can be reliably detected by video analysis.

The facial expression score calculation unit 108 calculates a score value for the facial expression recognized by the facial expression recognition unit 106. The facial expression score calculation unit 108 calculates a score that quantifies the degree of abnormality of abnormal facial expressions that cannot occur under normal circumstances, such as anger or fear. For example, the facial expression score calculation unit 108 outputs a larger value the more the recognized facial expression represents great anger or great fear. Note that, in a case where a score value for delight, anger, sorrow, or pleasure, such as the smile level or anger level, is obtained as a result of facial expression recognition, the facial expression score calculation unit 108 may output a score value using the score value for a predetermined facial expression, such as the anger level, obtained in the recognition processing.

The motion score calculation unit 109 calculates a score value for the motion recognized by the motion recognition unit 107. In the present example embodiment, the motion score calculation unit 109 calculates a score that quantifies the degree of abnormality regarding the motion stored in the abnormal behavior storage unit 123. For example, the motion score calculation unit 109 outputs a larger value the higher the similarity between the recognized series of motions and the motions stored in the abnormal behavior storage unit 123. The motion score calculation unit 109 may calculate different score values depending on which of the predefined motions the recognized motion corresponds to. In the present example embodiment, the motion score calculation unit 109 calculates a score that quantifies the degree of abnormality regarding the motion stored in the abnormal behavior storage unit 123, but may similarly calculate a score value regarding a gesture.

The secondary determination unit 110 determines whether or not a response is required for the abnormal situation that has occurred. Specifically, the secondary determination unit 110 uses the score values calculated by the facial expression score calculation unit 108 and the motion score calculation unit 109 and the results of the determination as to whether or not the gesture defined in the gesture storage unit 124 has been performed to determine whether or not a response is required. The secondary determination unit 110 uses these as inputs to determine whether or not a response is required according to a predetermined determination logic. The secondary determination unit 110 may use only some of these inputs to perform the determination. For example, the secondary determination unit 110 may determine that a response is required for the abnormal situation when the score value calculated by the facial expression score calculation unit 108 exceeds the first threshold value. In addition, the secondary determination unit 110 may determine that a response is required for the abnormal situation when the score value calculated by the motion score calculation unit 109 exceeds the second threshold value. In addition, the secondary determination unit 110 may determine that a response is required for the abnormal situation when the sum of the calculated two score values exceeds the third threshold value. In addition, the secondary determination unit 110 may determine that a response is required for the abnormal situation when a predefined gesture is performed. In addition, the secondary determination unit 110 may change the above-described threshold value depending on whether or not a predefined gesture has been performed. That is, in a case where the predefined gesture is performed, a threshold value lower than that in a case where the predefined gesture is not performed may be used. Note that the above-described determination logic is merely an example, and the secondary determination unit 110 may use any determination logic. As described above, in the present example embodiment, the secondary determination unit 110 evaluates an abnormal situation in the monitoring target area 90 based on the results of video analysis.

In a case where the secondary determination unit 110 determines that a response is required for the generated abnormal situation, the signal output unit 111 outputs a predetermined signal to respond to the abnormal situation. That is, the signal output unit 111 outputs a predetermined signal in a case where the evaluation of the abnormal situation satisfies a predetermined criterion. The predetermined signal may be a signal for giving a predetermined instruction to another program (another device) or a human. For example, the predetermined signal may be a signal to trigger an alarm lamp and an alarm sound in a security guard room or the like, or may be a message instructing a security guard or the like to respond to the abnormal situation. In addition, the predetermined signal may be a signal to flash a warning light near the occurrence position of the abnormal situation to suppress a criminal act, or may be a signal to output an alarm to urge people near the occurrence position of the abnormal situation to evacuate.

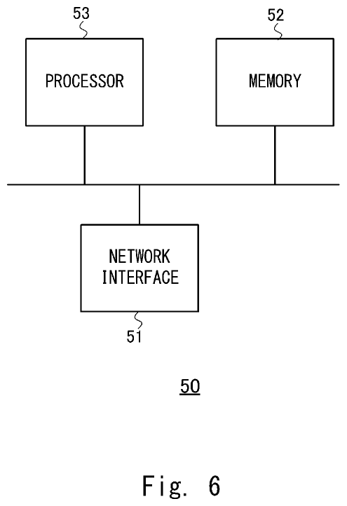

The functions illustrated in FIG. 4 and the functions illustrated in FIG. 5 may be realized by, for example, a computer 50 as illustrated in FIG. 6. FIG. 6 is a schematic diagram illustrating an example of the hardware configuration of the computer 50. As illustrated in FIG. 6, the computer 50 includes a network interface 51, a memory 52, and a processor 53.

The network interface 51 is used to communicate with any other device. The network interface 51 may include, for example, a network interface card (NIC).

The memory 52 includes, for example, a combination of a volatile memory and a nonvolatile memory. The memory 52 is used to store programs including one or more instructions executed by the processor 53, data used for various types of processing, and the like.

The processor 53 reads a program from the memory 52 and executes the program to perform processing of each component illustrated in FIG. 4 or 5. The processor 53 may be, for example, a microprocessor, a microprocessor unit (MPU), or a central processing unit (CPU). The processor 53 may include a plurality of processors.

The program includes a group of instructions (or software code) for causing a computer to perform one or more functions described in the example embodiment when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals.

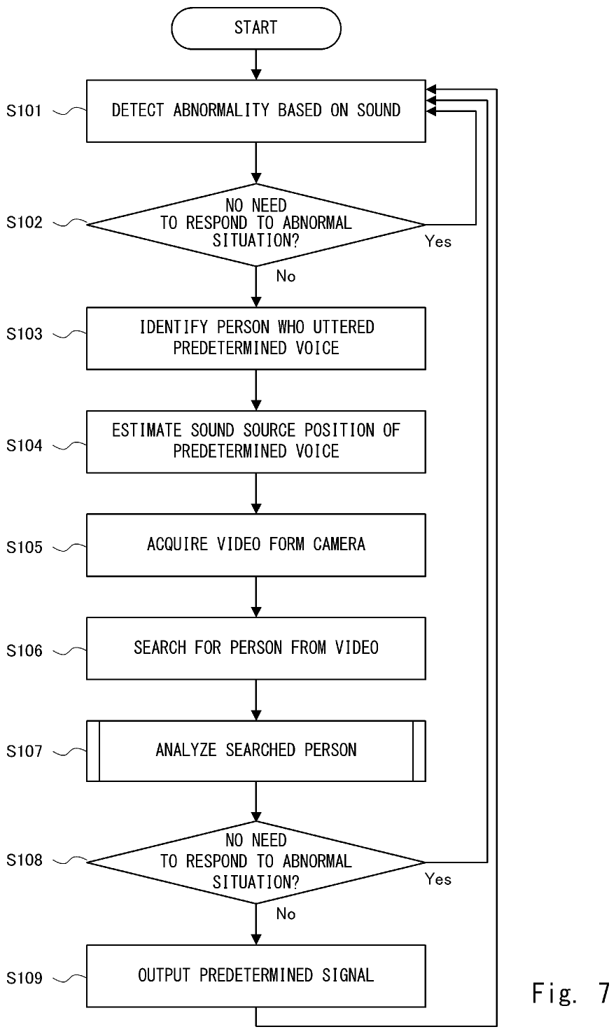

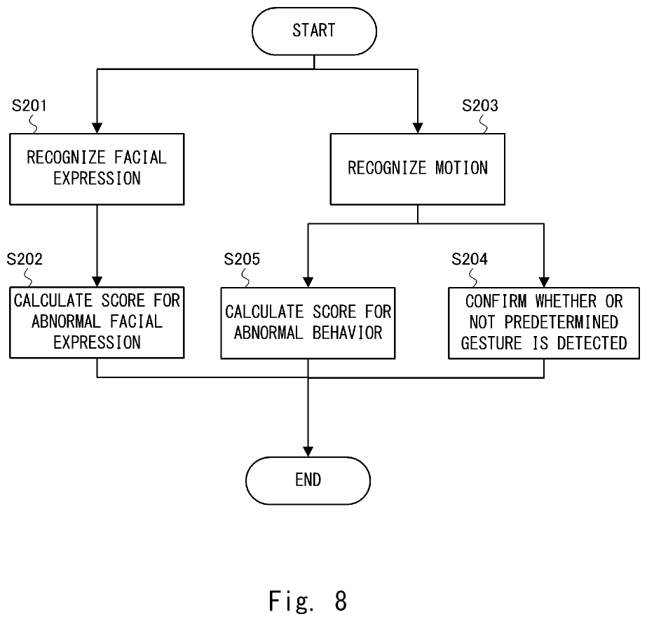

Next, the flow of the operation of the monitoring system 10 will be described. FIG. 7 is a flowchart illustrating an example of the flow of the operation of the monitoring system 10. In addition, FIG. 8 is a flowchart illustrating an example of the flow of processing in step S107 in the flowchart illustrated in FIG. 7.

An example of the flow of operation of the monitoring system 10 is described below with reference to FIGS. 7 and 8. In the present example embodiment, steps S101 and S102 are executed as processing of the acoustic sensor 300, and processing after step S103 is executed as processing of the analysis server 100.

In step S101, the abnormality detection unit 301 detects the occurrence of an abnormal situation in the monitoring target area 90 based on the sound detected by the acoustic sensor 300.

Next, in step S102, the primary determination unit 302 determines whether or not a response is unnecessary for the abnormal situation that has occurred. When it is determined that no response is required for the abnormal situation that has occurred (Yes in step S102), the processing returns to step S101, and otherwise (No in step S102), the processing proceeds to step S103.

In step S103, the voice acquisition unit 101 acquires a predetermined voice from the acoustic sensor 300, and the person identification unit 102 identifies the person who uttered the predetermined voice based on features obtained from the predetermined voice acquired by the voice acquisition unit 101.

Next, in step S104, the sound source position estimation unit 103 estimates the sound source position of the predetermined voice (the occurrence position of the abnormal situation) based on the output of the acoustic sensor 300.

Next, in step S105, in order to analyze the vides, the video acquisition unit 104 acquires video data from the monitoring camera 200 shooting the occurrence position of the abnormal situation out of all the monitoring cameras 200 installed in the monitoring target area 90. Therefore, the analysis processing is performed only for the video data of the monitoring camera 200 shooting the area including the occurrence position of the abnormal situation (the area including the sound source position) out of the plurality of monitoring cameras 200.

Furthermore, the analysis processing may be performed only on the partial images that are partial images in the images constituting the video and include the sound source position. That is, the analysis processing may be performed only on partial images corresponding to a partial area, not on the entire area captured by the monitoring camera 200 shooting the area including the sound source position.

In addition, in the present example embodiment, the video analysis processing is not executed during normal times, and is executed only when an abnormal situation occurs. That is, the analysis processing using the video from the monitoring camera 200 is executed when the occurrence of an abnormal situation is detected (specifically, in a case where a predetermined sound is detected), but is not executed before the occurrence of an abnormal situation is detected (before the predetermined voice is detected).

Next, in step S106, the person search unit 105 searches for the person identified by the person identification unit 102 from the video acquired in step S105 based on the features of the appearance of the person.

Next, in step S107, video analysis is performed on the searched person. The processing of step S107 will be specifically described with reference to FIG. 8. In the video analysis, first, the processing of step S201 and step S203 is performed. Note that step S201 and its subsequent processing and step S203 and its subsequent processing are executed in parallel, for example, but may be sequentially executed.

In step S201, the facial expression recognition unit 106 recognizes the facial expression of the person searched in step S106. After step S201, in step S202, the facial expression score calculation unit 108 calculates the score value for the abnormal facial expression based on the recognition result in step S201.

Meanwhile, in step S203, the motion recognition unit 107 recognizes the motion of the person searched in step S106. After step S203, in step S204, the motion recognition unit 107 checks whether or not a gesture stored in the gesture storage unit 124 has been detected. After step S203, in step S205, the motion score calculation unit 109 calculates the score value regarding the motion stored in the abnormal behavior storage unit 123 based on the results of recognition in step S203.

When the processing of steps S202, S204, and S205 are completed, the processing proceeds to step S108 illustrated in FIG. 7.

Next, in step S108, the secondary determination unit 110 determines whether or not a response is unnecessary for the abnormal situation that has occurred based on the results of the processing in step S107. When it is determined that no response is required for the abnormal situation that has occurred (Yes in step S108), the processing returns to step S101, and otherwise (No in step S108), the processing proceeds to step S109.

In step S109, the signal output unit 111 outputs a predetermined signal to respond to the abnormal situation. This makes it possible to respond to the abnormal situation. After step S109, the processing returns to step S101.

The example embodiment has been described above. The monitoring system 10 performs processing using voice and video as described above, whereby the occurrence of an abnormal situation can be detected and the abnormal situation can be appropriately ascertained.

In particular, the monitoring system 10 first detects the occurrence of an abnormal situation from an abnormal voice uttered by a person, and identifies the person who uttered the abnormal voice based on the features of the voice. Then, the monitoring system 10 performs detailed confirmation processing on the occurrence of the abnormal situation by analyzing the facial expression and behavior of the person who uttered the abnormal voice based on the video. As described above, in the present example embodiment, the analysis on the video is performed together with the detection of the abnormal voice. The reason for this is that the types of crimes and accidents are so varied that it is difficult to define video features for unexpected abnormal situations in advance unless some preconditions are added. That is, once the precondition “the person who uttered an abnormal voice” is added, it is easy to confirm the occurrence of an abnormal situation from the facial expression or behavior of the person appearing in the video. That is, such a precondition makes it easy to distinguish, for example, between the behavior of receiving a payment from a customer and handing over change from a cash register and the behavior of handing over cash from a cash register after by being threatened by a burglar.

In addition, there are the following advantages of performing processing using sound and video. Detection of occurrence of an abnormal situation by sound analysis is effective for unexpected abnormal situations, but it is difficult to evaluate whether or not a response is required for the detected abnormal situation only by sound analysis. Abnormality detection by sound is similar to when a person closes his or her eyes and listens closely. Even though it is possible to recognize that an abnormal situation is likely to have occurred through the detection of a scream or shout, it is not possible to ascertain further details of the situation. Therefore, it is difficult to ascertain the details of the abnormal situation from the sound, for example, whether the security guard or the like should be dispatched immediately or whether the abnormality is minor enough to wait until the next day before checking. On the other hand, by adding video analysis of the facial expression or behavior of the person who uttered the abnormal voice, it is possible to evaluate the abnormal situation in detail. As described above, in the present example embodiment, multimodal analysis using sound and video is realized by first detecting the occurrence of an abnormal situation based on an abnormal voice uttered by a person, identifying the person who uttered the abnormal voice, and then analyzing the facial expression and behavior of the person based on the video of the person.

Furthermore, as described above, the video analysis processing in the analysis server 100 may be performed only on the video in the vicinity of the sound source position of the abnormal voice. That is, analysis may be performed only on the video from the monitoring camera 200 shooting the position estimated to be the sound source position out of the videos from the plurality of monitoring cameras 200. Furthermore, the analysis may be performed only on a partial image that is cut out from the video from one monitoring camera 200 and includes the position estimated to be the sound source position. Analyzing videos in real time requires significant computer resources. However, in the present example embodiment, the use of the computer resources can be suppressed by analyzing only the video in the vicinity of the sound source position. Furthermore, according to the present example embodiment, as described above, the video analysis processing is not executed during normal times, but is executed only when an abnormal situation is detected by sound. Therefore, according to the present example embodiment, the use of computer resources can be further suppressed.

### MODIFIED EXAMPLE OF EXAMPLE EMBODIMENT

In the above-described example embodiment, the acoustic sensors 300 are disposed, and each acoustic sensor 300 includes the abnormality detection unit 301 and the primary determination unit 302. However, instead of such a configuration, the monitoring system may be composed of the following configuration. That is, a microphone may be arranged in the monitoring target area 90 instead of the acoustic sensor 300, and the voice signals collected by the microphone may be transmitted to the analysis server 100, which performs acoustic analysis and voice recognition. That is, among the components of the acoustic sensor 300, at least only the microphone needs to be arranged in the monitoring target area 90, and the other components do not need to be arranged in the monitoring target area 90. As described above, the processing in the abnormality detection unit 301 and the primary determination unit 302 described above may be realized by the analysis server 100.

Note that the monitoring method described in the above-described example embodiment may be implemented and sold as a monitoring program. In this case, since the user can install and use it on any hardware, convenience is improved. In addition, the monitoring method described in the above-described example embodiment may be implemented as a monitoring device. In this case, the user can use the monitoring method described above without having to prepare the hardware and install the program by himself/herself, which improves convenience. In addition, the monitoring method described in the above-described example embodiment may be implemented as a system including a plurality of devices. In this case, the user can use the monitoring method described above without having to combine and adjusting a plurality of devices by himself/herself, which improves convenience.

Although the present invention has been described above with reference to the example embodiments, the present invention is not limited to the above. Various modifications that can be understood by those skilled in the art can be made to the configuration and details of the present invention within the scope of the present invention.

Some or all of the above example embodiments may be described as the following supplementary notes, but are not limited to the following.

### (Supplementary Note 1)

A monitoring device including:
a voice acquisition means for acquiring a predetermined voice uttered by a person due to the occurrence of an abnormal situation in a monitoring target area;
a person identification means for identifying the person who uttered the predetermined voice based on features obtained from the predetermined voice;
an analysis means for searching for the identified person from a video from a camera shooting the monitoring target area and analyzing a facial expression or a motion of the person; and
an abnormal situation evaluation means for evaluating the abnormal situation in the monitoring target area based on a result of the analysis.

### (Supplementary Note 2)

The monitoring device according to Supplementary Note 1, in which the analysis means analyzes whether or not the facial expression of the person is a predetermined facial expression.

### (Supplementary Note 3)

The monitoring device according to Supplementary Note 1 or 2, in which the analysis means analyzes whether or not the motion of the person is similar to a predefined series of motions.

### (Supplementary Note 4)

The monitoring device according to any one of Supplementary Notes 1 to 3, in which the analysis means analyzes whether or not the motion of the person is similar to a predefined gesture.

### (Supplementary Note 5)

The monitoring device according to any one of Supplementary Notes 1 to 4, in which analysis processing by the analysis means is executed when the predetermined voice is detected, and is not executed before the predetermined voice is detected.

### (Supplementary Note 6)

The monitoring device according to any one of Supplementary Notes 1 to 5, further including a sound source position estimating means for estimating a sound source position of the predetermined voice,
in which the analysis means performs analysis processing only on video data from the camera shooting the area including the sound source position, among a plurality of the cameras.

### (Supplementary Note 7)

The monitoring device according to Supplementary Note 6, in which the analysis means performs analysis processing only for the partial image including the sound source position in the image constituting the video.

### (Supplementary Note 8)

The monitoring device according to any one of Supplementary Notes 1 to 7, further including a signal output means for outputting a predetermined signal when the evaluation of the abnormal situation satisfies a predetermined criterion.

### (Supplementary Note 9)

A monitoring system including:
a camera configured to shoot a monitoring target area;
a sensor configured to detect a sound generated in a monitoring target area; and
a monitoring device,
in which the monitoring device includes:
a voice acquisition means for acquiring, from the sensor, a predetermined voice uttered by a person due to the occurrence of an abnormal situation in the monitoring target area;
a person identification means for identifying the person who uttered the predetermined voice based on features obtained from the predetermined voice;
an analysis means for searching for the identified person from a video from the camera and analyzing a facial expression or a motion of the person; and
an abnormal situation evaluation means for evaluating the abnormal situation in the monitoring target area based on a result of the analysis.

### (Supplementary Note 10)

The monitoring system according to Supplementary Note 9, in which the analysis means analyzes whether or not the facial expression of the person is a predetermined facial expression.

### (Supplementary Note 11)

The monitoring system according to Supplementary Note 9 or 10, in which the analysis means analyzes whether or not the motion of the person is similar to a predefined series of motions.

### (Supplementary Note 12)

The monitoring system according to any one of Supplementary Notes 9 to 11, in which the analysis means analyzes whether or not the motion of the person is similar to a predefined gesture.

### (Supplementary Note 13)

A monitoring method including:
acquiring a predetermined voice uttered by a person due to the occurrence of an abnormal situation in a monitoring target area;
identifying the person who uttered the predetermined voice based on features obtained from the predetermined voice;
searching for the identified person from a video from a camera shooting the monitoring target area and analyzing a facial expression or a motion of the person; and
evaluating the abnormal situation in the monitoring target area based on a result of the analysis.

### (Supplementary Note 14)

A non-transitory computer-readable medium storing a program causing a computer to execute:
a voice acquisition step of acquiring a predetermined voice uttered by a person due to the occurrence of an abnormal situation in a monitoring target area;
a person identification step of identifying the person who uttered the predetermined voice based on features obtained from the predetermined voice;
an analysis step of searching for the identified person from a video from a camera shooting the monitoring target area and analyzing a facial expression or a motion of the person; and
an abnormal situation evaluation step of evaluating the abnormal situation in the monitoring target area based on a result of the analysis.

### REFERENCE SIGNS LIST

1 MONITORING DEVICE
2 VOICE ACQUISITION UNIT
3 PERSON IDENTIFICATION UNIT
4 ANALYSIS UNIT
5 ABNORMAL SITUATION EVALUATION UNIT
10 MONITORING SYSTEM
50 COMPUTER
51 NETWORK INTERFACE
52 MEMORY
53 PROCESSOR
90 MONITORING TARGET AREA
100 ANALYSIS SERVER
101 VOICE ACQUISITION UNIT
102 PERSON IDENTIFICATION UNIT
103 SOUND SOURCE POSITION ESTIMATION UNIT
104 VIDEO ACQUISITION UNIT
105 PERSON SEARCH UNIT
106 FACIAL EXPRESSION RECOGNITION UNIT
107 MOTION RECOGNITION UNIT
108 FACIAL EXPRESSION SCORE CALCULATION UNIT
109 MOTION SCORE CALCULATION UNIT
110 SECONDARY DETERMINATION UNIT
111 SIGNAL OUTPUT UNIT
121 VOICE FEATURE STORAGE UNIT
122 APPEARANCE FEATURE STORAGE UNIT
123 ABNORMAL BEHAVIOR STORAGE UNIT
124 GESTURE STORAGE UNIT
200 MONITORING CAMERA
300 ACOUSTIC SENSOR
301 ABNORMALITY DETECTION UNIT
302 PRIMARY DETERMINATION UNIT
500 NETWORK

What is claimed is:

1. A monitoring device comprising:
at least one memory storing instructions; and
at least one processor configured to execute the instructions to:
acquire a predetermined voice uttered by a person due to the occurrence of an abnormal situation in a monitoring target area;
identify the person who uttered the predetermined voice based on features obtained from the predetermined voice;
search for the identified person from a video from a camera shooting the monitoring target area and analyze a facial expression or a motion of the person; and
evaluate the abnormal situation in the monitoring target area based on a result of the analysis.

2. The monitoring device according to claim 1, wherein the processor is configured to execute the instructions to analyze whether or not the facial expression of the person is a predetermined facial expression.

3. The monitoring device according to claim 1, wherein the processor is configured to execute the instructions to analyze whether or not the motion of the person is similar to a predefined series of motions.

4. The monitoring device according to claim 1, wherein the processor is configured to execute the instructions to analyze whether or not the motion of the person is similar to a predefined gesture.

5. The monitoring device according to claim 1, wherein analysis processing for the analyzing the facial expression or the motion of the person is executed when the predetermined voice is detected, and is not executed before the predetermined voice is detected.

6. The monitoring device according to claim 1, wherein
the processor is further configured to execute the instructions to estimate a sound source position of the predetermined voice, and
analysis processing for the analyzing the facial expression or the motion of the person is performed only on video data from the camera shooting the area including the sound source position, among a plurality of the cameras.

7. The monitoring device according to claim 6, wherein analysis processing for the analyzing the facial expression or the motion of the person is performed only for the partial image including the sound source position in the image constituting the video.

8. The monitoring device according to claim 1, wherein
the processor is further configured to execute the instructions to output a predetermined signal when the evaluation of the abnormal situation satisfies a predetermined criterion.

9.-12. (canceled)

13. A monitoring method comprising:
acquiring a predetermined voice uttered by a person due to the occurrence of an abnormal situation in a monitoring target area;
identifying the person who uttered the predetermined voice based on features obtained from the predetermined voice;
searching for the identified person from a video from a camera shooting the monitoring target area and analyzing a facial expression or a motion of the person; and
evaluating the abnormal situation in the monitoring target area based on a result of the analysis.

14. A non-transitory computer-readable medium storing a program causing a computer to execute:
a voice acquisition step of acquiring a predetermined voice uttered by a person due to the occurrence of an abnormal situation in a monitoring target area;
a person identification step of identifying the person who uttered the predetermined voice based on features obtained from the predetermined voice;
an analysis step of searching for the identified person from a video from a camera shooting the monitoring target area and analyzing a facial expression or a motion of the person; and
an abnormal situation evaluation step of evaluating the abnormal situation in the monitoring target area based on a result of the analysis.

15. The monitoring method according to claim 13, wherein the method comprises analyzing whether or not the facial expression of the person is a predetermined facial expression.

16. The monitoring method according to claim 13, wherein the method comprises analyzing whether or not the motion of the person is similar to a predefined series of motions.

17. The monitoring method according to claim 13, wherein the method comprises analyzing whether or not the motion of the person is similar to a predefined gesture.

18. The monitoring method according to claim 13, wherein analysis processing for the analyzing the facial expression or the motion of the person is executed when the predetermined voice is detected, and is not executed before the predetermined voice is detected.

19. The monitoring method according to claim 13, wherein
the method further comprises estimating a sound source position of the predetermined voice, and
analysis processing for the analyzing the facial expression or the motion of the person is performed only on video data from the camera shooting the area including the sound source position, among a plurality of the cameras.

20. The non-transitory computer-readable medium according to claim 14, wherein the analysis step comprises analyzing whether or not the facial expression of the person is a predetermined facial expression.

21. The non-transitory computer-readable medium according to claim 14, wherein the analysis step comprises analyzing whether or not the motion of the person is similar to a predefined series of motions.

22. The non-transitory computer-readable medium according to claim 14, wherein the analysis step comprises analyzing whether or not the motion of the person is similar to a predefined gesture.

23. The non-transitory computer-readable medium according to claim 14, wherein the analysis step is executed when the predetermined voice is detected, and is not executed before the predetermined voice is detected.

24. The non-transitory computer-readable medium according to claim 14, wherein
the program further causes the computer to execute a sound source position estimating step of estimating a sound source position of the predetermined voice, and
the analysis step is performed only on video data from the camera shooting the area including the sound source position, among a plurality of the cameras.
